(19) United States
(12) Patent Application Publication
(10) Pub. No.: US 2014/0379399 A1
(43) Pub. Date: Dec. 25, 2014

(54) Method and System for Dynamically Determining Completion Status in a Human Intelligence System

(71) Applicants: Owen Brydon, Mountain View, CA (US); Shailesh Kochhar, San Francisco, CA (US)

(72) Inventors: Owen Brydon, Mountain View, CA (US); Shailesh Kochhar, San Francisco, CA (US)

(73) Assignee: GOOGLE INC., Mountain View, CA (US)

(21) Appl. No.: 13/448,461

(22) Filed: Apr. 17, 2012

(51) Int. Cl. G06Q 10/06

(52) U.S. Cl. 705/7.15

(57) ABSTRACT

Methods and systems for dynamically determining completion status in a human intelligence system are disclosed. Requestors can specify completion criteria data for tasks that include one or more completion rules that define what constitutes sufficient responses for the task to be considered completed. The completion criteria data can be specified in a unique data structure independent of the data structure for task data or response data. Rather, than immediately sending tasks to a predefined number of human workers specified by the requestors, such as a predefined maximum number of human workers, the completion criteria data can be analyzed to determine a minimum number of human workers necessary to meet the completion criteria. The task can then be sent to the minimum number of human workers for response.

### FIELD

The present disclosure relates generally to human intelligence systems, and more particularly to determining completion status of tasks in human intelligence systems.

### BACKGROUND

Human intelligence systems are used to harness human intelligence to complete one or more tasks. For instance, human intelligence systems such as crowdsourcing markets have become increasingly used to provide a variety of tasks, typically in the form of an open call, for completion by large groups of people. With the advance of the Internet, crowdsourcing services can provide online marketplaces where businesses and other entities can submit tasks for completion by thousands of workers online. For instance, crowdsourcing markets, such as the Mechanical Turk crowdsourcing market by Amazon.com Inc., offer thousands of human workers with differing expertise to complete a variety of tasks on call.

In typical human intelligence systems, requestors submit tasks for completion by one or more human workers. Example tasks submitted for completion by human workers can include selecting a best photograph of a particular object or geographic area, translating text, transcribing a recording, verifying search results, or other suitable tasks. The tasks are then provided or crowdsourced to one or more human workers who review the task and provide a response to the task. The human workers can receive compensation or other reward for completing the task.

In certain instances, it can be desirable to submit the same task for completion by multiple workers for comparison purposes and to ensure the accuracy of responses. Submitting tasks for completion by more human workers than necessary for a given task, however, can result in a waste of resources and excess costs. In addition, it can be difficult in many cases to compare responses from different workers to determine the completion status of tasks. The structure of responses provided to the tasks by human workers can often be in one of many different types of format as defined by the requestors. As such, a human intelligence system may not inherently know how to compare answers to the same task from multiple human workers to determine whether the task is complete.

### SUMMARY

Aspects and advantages of the invention will be set forth in part in the following description, or may be obvious from the description, or may be learned through practice of the invention.

One exemplary aspect of the present disclosure is directed to a computer-implemented method of obtaining a plurality of responses to a task in a human intelligence system. The method includes receiving, at a computing device, a task for completion by a plurality of human workers and receiving, at the computing device, completion criteria data for the task. The completion criteria data define at least one completion rule that when satisfied signifies completion of the task. The method further includes determining, with the computing device, a minimum number of human workers to satisfy the completion criteria data for the task and providing, via a network interface, the task for completion by the minimum number of human workers. The method further includes receiving, at the computing device, responses to the task from the minimum number of workers; determining, with the computing device, whether the completion criteria data is satisfied based on the responses to the task from the minimum number of workers; and incrementally providing, via the network interface, the task for completion by an additional human worker until the completion criteria data is satisfied. According to particular aspects of the present disclosure, the completion criteria data can be defined in a completion criteria data structure independent of a data structure associated with the task.

Other exemplary implementations of the present disclosure are directed to systems, apparatus, computer-readable media, devices, and user interfaces for obtaining responses to a task in a human intelligence system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a block diagram of an exemplary human intelligence system according to an exemplary aspect of the present disclosure;

FIG. 2 provides a flow diagram of an exemplary method according to an exemplary embodiment of the present disclosure; and

FIG. 3 provides a block diagram of a computer based human intelligence system according to an exemplary aspect of the present disclosure

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for obtaining responses to tasks from human workers in a human intelligence system. Human intelligence systems often route the same task for completion by multiple different human workers. The responses from the multiple different human workers can be analyzed and/or compared to verify the accuracy of the responses and/or to determine whether the task has been satisfactorily completed. According to aspects of the present disclosure, requestors can specify completion criteria data for tasks that include one or more completion rules that define what constitutes sufficient responses for the task to be considered completed. Rather, than immediately sending tasks to a predefined number of human workers specified by the requestors, such as a predefined maximum number of human workers, the completion criteria data can be analyzed to determine a minimum number of human workers necessary to meet the completion criteria. The task can then be sent to the minimum number of human workers for response.

After receiving responses from the minimum number of workers, it can be determined whether the completion criteria data have been satisfied. If so, the task can be determined to be complete. If the completion criteria data have not been satisfied, the task can be incrementally sent to one additional human worker until the completion criteria data are satisfied or until a specified maximum number of human workers has been reached. In this manner, the subject matter of the present disclosure provides a mechanism for reducing the number of human workers necessary to provide a response to a task for the task to be considered completed. This can provide for a more efficient use of human resources and can lead to significant cost savings.

According to a particular aspect of the present disclosure, the completion criteria data can be defined in a data structure independent of a data structure associated with the task and associated with responses to the task. The completion criteria data structure can facilitate comparison of responses provided by the human workers across a wide range of varying formats. The completion criteria data structure can also provide increased flexibility for a requestor to specify complex completion rules for the task. For instance, the completion criteria data structure can include completion rules that include match count requirements that specify the number of responses that must agree to satisfy a completion rule. The completion criteria data structure can further include field constraints that map the match count requirements to one or more fields of a data structure associated with responses to the task. According to a particular aspect, the completion criteria data structure can also define a plurality of completion rules such that if any one of the completion rules is satisfied, the task can be considered to be completed. This allows a requestor to define multiple different ways of achieving completion of a task.

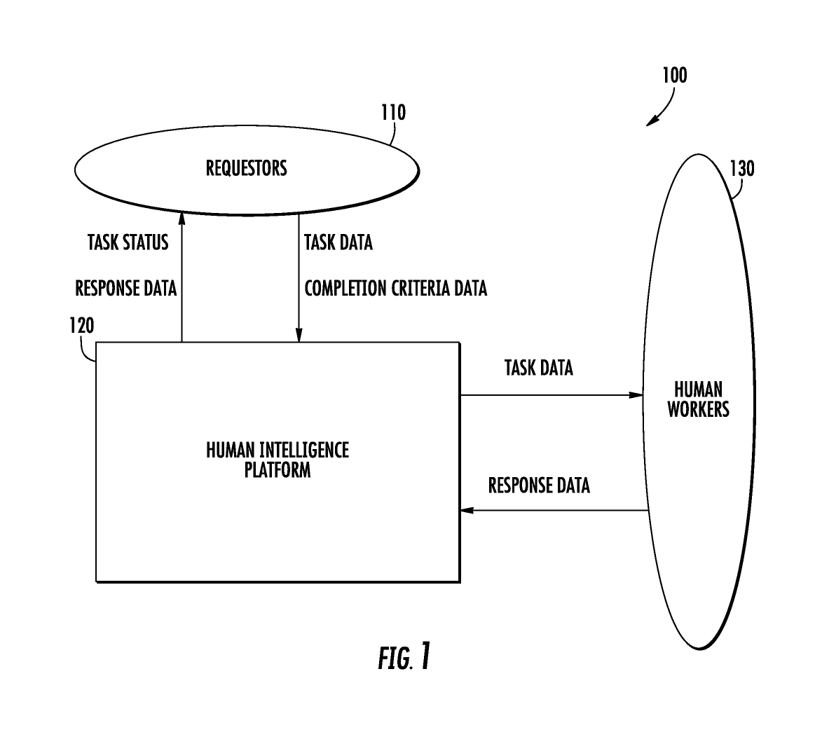

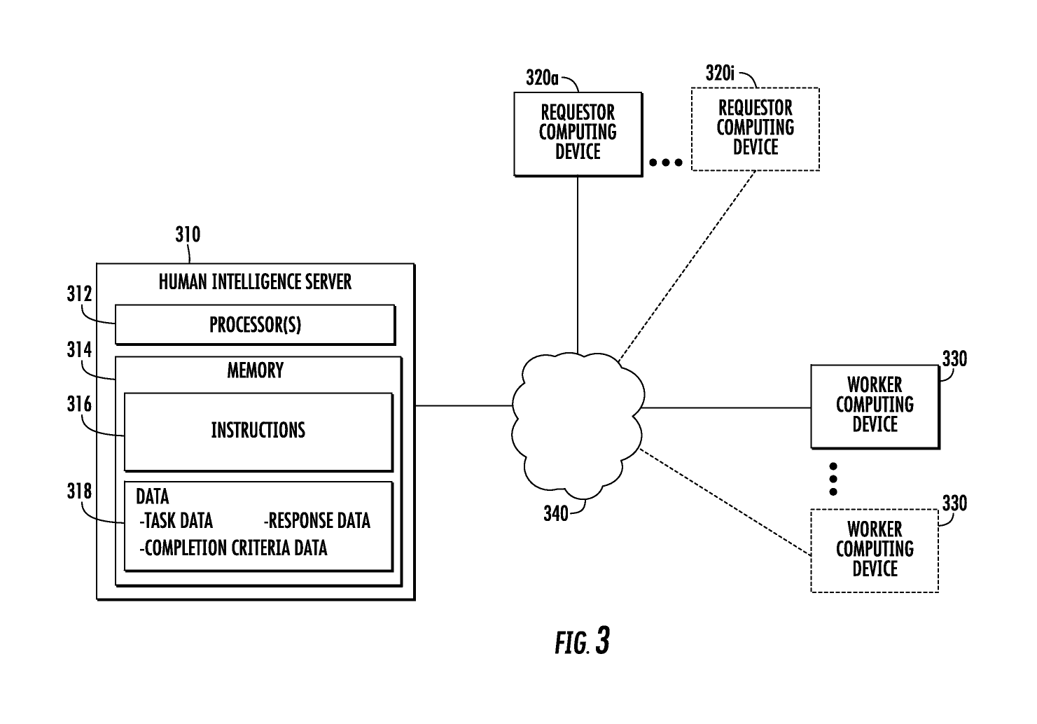

FIG. 1 depicts an overview of exemplary human intelligence system 100 according to an exemplary embodiment of the present disclosure. The human intelligence system 100 uses the intelligence of human workers 130 to obtain solutions for tasks. The human intelligence system 100 can be implemented across one or more computing devices, such as the computer based system depicted in FIG. 3.

Referring to FIG. 1, the human intelligence system 100 includes a human intelligence platform 120 that receives requests from businesses and other entities, collectively referred to as requestors 110, for tasks to be provided to human workers 130 for response. In certain exemplary aspects, the tasks can be crowdsourced to many human workers 130 pursuant to an open call for responses. Exemplary tasks can include tasks that computing systems may be unable to perform or would be impractical for computing systems to perform. For instance, exemplary tasks can include annotating images, translating documents, verifying search results, data collection or compilation, selecting a best image of a particular object, rewriting a sentence or paragraph, or other suitable task. Those of ordinary skill in the art, using the disclosures provided herein, should understand that the present invention is not limited to any particular task or request.

Requestors 110 can submit task data associated with the tasks to the human intelligence platform 120. For instance, a requestor 110 can input task data using an appropriate user interface presented a computing device associated with the requestor 110. The task data can be used to define one or more tasks for completion by human workers 130. The task data can be defined in a task data structure that is unique to or defined by the particular requestor. For instance, the task data can be defined in one or more protocol buffers or other format. The task data can include data and/or computer-executable code to facilitate human worker response to a particular task. For instance, the task data can include a web page to facilitate human worker response to a task. As another example, the task data can include plugin code to facilitate human worker response to a task. For instance, the task data can include a web page with embedded code to be executed by the plugin.

The task data can also define a response data structure for response data to the task. For instance, if a response to a task is to be chosen from a set of particular responses, the response data structure can include the set of particular responses. In addition, the response data structure can define one or more fields that can be populated with response data by human workers 130. For example, the response data structure can include a first field that asks for a particular response from a human worker 130 and a second field that asks the human worker 130 to provide an explanation associated with the response. The response data structure can be defined by the requestors 110 and can be of any format to provide flexibility to the requestors 110 in defining tasks for response by human workers 130.

The human intelligence platform 120 can be configured to receive the task data from the requestors 110 and to provide the task data for response by the human workers 130. A computing device associated with a human worker can process the task data to present the tasks for response by the human worker via a suitable user interface. If the task data includes computer executable code, the computing device can execute the computer executable code. The human workers 130 can respond to the tasks by providing response data in a manner specified by the response data structure.

After responding to the tasks provided by the human intelligence platform 120, the response data provided by the human worker 130 is provided to the human intelligence platform 120. The response data can then be provided by the human intelligence platform 120 to the requestor 130 along with other data, such as accuracy information associated with the task and other data. The human intelligence platform 120 can then arrange for compensation or other reward to be provided to the human workers 130 providing responses to the task.

The human intelligence platform 120 can be configured to provide various functionality associated with providing task data for response by a plurality of human workers 130. For instance, the human intelligence platform 120 can be configured to prioritize the tasks for response by the human workers 130. In one embodiment, the human intelligence platform 120 can organize tasks into queues with each queue being accorded a priority with respect to other queues. The human intelligence platform 120 can submit the tasks for completion by human workers 130 based on priorities assigned to the queues and the ordering of tasks within the queues.

As another example, the human intelligence platform 120 can be configured to monitor the accuracy of response data provided by human workers 130. For instance, the human intelligence platform 120 can be configured to periodically submit one or more gold units (e.g. tasks with known responses) to human workers 130 to assess the accuracy of a particular human worker 130. If a human worker 130 provides an incorrect response to one of the gold units, a training module or other suitable training platform can be provided to the human worker 130 to improve the capabilities of the human worker 130 for a task.

As another example, the human intelligence platform 120 can be configured to provide tasks to selected human workers 130 based on information associated with the human workers 130. For instance, in one application, the human intelligence platform 120 can collect data optionally provided by the human workers 130, such as age information, locality information, education information, and other suitable information. In addition, the human intelligence platform 120 can track accuracy information for the human workers 130 as the human workers 130 provide responses to one or more tasks. This accuracy can be an average accuracy for all human workers in a specified group or can be accuracies associated with individual human workers 130. The human intelligence platform 120 can be configured to select which human workers 130 to provide tasks for response based on the collected data associated with the human workers 130.

As yet another example, the human intelligence platform 120 can be configured to provide the same task to multiple different human workers 130 to achieve a desired replication for the task. The desired replication can be defined based on, for instance, a desired accuracy for the task. In a particular aspect, the task data can specify a predetermined number of human workers 130, such as a maximum number of human workers, to provide the task for response. The predetermined number of human workers can be specified in a replication field associated with the task data structure. Responses received from the multiple different human workers 130 can be compared and/or analyzed to assess the accuracy of the response data or otherwise verify or determine the suitability of the responses.

According to particular aspects of the present disclosure, the human intelligence platform 120 can be configured to track the status of a particular task. For instance, in one implementation, the human intelligence platform 120 can monitor the progress of a task as it progresses through the human intelligence system 100. The human intelligence platform 120 can provide notifications of the status of the task to the requestors 110.

For instance, a new task that is just received at the human intelligence platform 120 can be assigned a NEW status. As task data associated with the task is being received or downloaded, the task can be assigned a DOWNLOADING status. Once all the task data has been downloaded, the task can be assigned a READY status. After a human worker provides a response to the task, the task can be assigned an ANSWERED status. If the response data received for a particular task satisfies certain criteria, the task can be assigned a COMPLETED status. In one example, a task can be considered “completed” when response data has been received from a predefined number of human workers 130 as specified in the task data.

According to a particular aspect of the present disclosure, a requestor 110 can define completion criteria to be used in determining whether a task is completed. For instance, a requestor can specify one or more completion rules that govern when a task may be considered completed. The human intelligence platform 120 can be configured to analyze the responses provided by the multiple different human workers 130 to determine whether a particular task has received sufficient response data for the task to be considered completed in view of the completion criteria.

To facilitate comparison of response data from multiple different human workers 130, the requestors 110 can provide completion criteria data associated with a task. The completion criteria data can be defined in a data structure independent and separate from the data structure associated with the task data. This allows for a uniform data structure that can be used to specify completion criteria that can be applied to the many different possible formats of task data and response data specified by the requestor.

One exemplary completion criteria data structure can include a completion rule that is defined by the requestor 110. The completion rule governs when a task can be considered completed. In particular, if the completion rule is determined to be satisfied (e.g. the human intelligence platform 120 determines that the response data meets the requirements of the completion rule), then the task can be considered complete. In certain applications, the completion criteria data structure can include a plurality of different completion rules. The completion criteria for the task can be considered satisfied when any one of the plurality of different completion rules is satisfied. In this manner, the completion criteria data structure can allow a requestor 110 to specify multiple different ways of achieving completion for a task.

Each of the individual completion rules defined in the completion criteria data structure can include at least one match count requirement. The match count requirement specifies the number of responses from human workers that must agree or match to satisfy the completion rule. For instance, a match count requirement of two would require two human workers to agree on a response to a task before the response could be considered complete. For responses to be considered to match or to agree, the response data associated with responses must be the same.

The response data can include simple data in which case the simple data must be substantially identical for the response to be considered to match or agree. The response data can further include one or more sub messages defined pursuant to a data structure associated with the response data. For instance, the sub message could map response data to a field of the original response data structure. The sub message itself could include further sub messages and so on. In the event the response data includes sub messages, the sub message data associated with the sub messages must be substantially identical for the response to be considered to match or agree.

Each of the individual completion rules defined in the completion criteria data structure can also include zero or more field constraints. The field constraints map a match count requirement to a particular field in the response data structure specified for the task. The field constraints require response data in a specific field in the response data structure to agree or match for the completion rule to be satisfied. As an example, a response data structure can include two separate fields: field “foo” and field “bar”. A field constraint can map a match count requirement to one or more of the two separate fields. If the field constraint maps the match count requirement to field “foo”, then response data, including any sub messages in the response data structure, associated with field “foo” must agree in accordance with the match count requirement to satisfy the completion rule. If the field constraint maps the match count requirement to field “bar”, then response data, including any sub messages, associated with field “bar” must agree in accordance with the match count requirement to satisfy the completion rule.

In the event the response data structure includes a plurality of repeated fields, the field constraints can map the match count requirement to either all of the repeated fields generally or to a specific item in a repeated field. For instance, a field constraint can generally specify a field “foo” or can refer to specific item in a repeated field at a specific index “foo[3].” Absence of a field constraint for a completion rule can indicate that the entire response data for a task has to match. In addition, all field constraints associated with a particular completion rule must be met for the completion rule to be considered satisfied.

The field constraints can include a field name and can optionally include a value constraint. The field name maps the field constraint to a particular field in the response data structure. The value constraint can specify a particular value for data in the field for the data to be counted towards the match count requirement. For instance, the value constraint can be satisfied when response data in the specified field of the response data structure is equal to the value specified in the value constraint. Response data that includes other values in the specified field is ignored for purposes of determining whether the match count requirement is satisfied. The value constraint can be simple data and can be expressed as a string. Alternatively, the value constraint can refer to a sub message specified in the response data structure. The sub message itself can refer to further sub messages and so on.

The completion criteria data structure in accordance with aspects of the present disclosure provides increased flexibility to requestors in defining completion criteria for tasks. To illustrate this flexibility, exemplary applications of the completion criteria data structure will now be set forth.

A mechanism for implementing the completion criteria data structure according to an exemplary embodiment of the present disclosure can be defined pursuant to a protocol buffer of the following (or similar) format:

message Completion {

message CompletionRule {

required int32 match_count = 1;
message FieldConstraint {

required string fieldname = 1;
optional string valueconstraint = 2;

}

repeated FieldConstraint field_constraints =2;

}

Repeated CompletionRule criteria =1;

}

This exemplary data structure format can be used to define a set of repeated completion rules where if any match, the task is considered complete. Field constraints define which fields of a response data structure are of interest and potentially what their value should be. Absence of a field constraint for a completion rule can indicate that the entire response data for a task has to match.

Consider a first exemplary completion criterion that specifies that a task is considered complete when two human workers agree on a response to the task. To implement this completion criterion, the completion criteria data structure can include a completion rule that includes a match count requirement of two and no field constraints. An exemplary implementation of this completion rule in the completion criteria data structure can be as follows:

criteria <match_count: 2>

Consider a second exemplary completion criterion that specifies that a task is complete when two human workers agree on a response in both fields “foo” and “bar” in a response data structure specified for the task. To implement this completion criterion, the completion data structure can include a completion rule that specifies a match count requirement of two in addition to specifying two field constraints—one for the field “foo” and one for the field “bar.” An exemplary implementation of this completion rule in the completion criteria data structure can be as follows:

criteria <

match_count: 2
field_constraints < fieldname: “foo” >
field_constraints < fieldname: “bar” >

>

Consider a third exemplary completion criterion that specifies that a task is complete if a single human worker responds with a “NO” response or if two human workers respond with a “YES” response. To implement this completion criterion, the completion criteria data structure can specify a first completion rule that includes a match count requirement of one for a field constraint “foo” and a value constraint of “NO.” The completion criteria data structure can specify a second completion rule that specifies a match count requirement of two for a field constraint “foo” and a value constraint of “YES.” An exemplary implementation of these completion rules in the completion criteria data structure can be as follows:

criteria <

match_count: 1
field_constraints < fieldname: “foo” valueconstraint NO >

>
criteria <

match_count: 2
field_constraints < fieldname: “foo” valueconstraint YES>

>

As illustrated in the foregoing examples, the completion criteria data structure can provide increased flexibility in determining the completion status of tasks. In addition to providing flexibility in assessing the completion status of tasks, the completion criteria data structure can also be used to improve the efficiency of obtaining completion of one or more tasks.

More particularly, a requestor 110 can provide task data to the human intelligence platform 120 that specifies a predetermined number of human workers 130 to provide a specific task in order to achieve desired replication for the task. For instance, the task data can specify a maximum number of human workers to provide the task for response. Instead of automatically providing the task to the maximum number of human workers specified in the task data, the human intelligence platform 120 can be configured to analyze the completion criteria data to identify a minimum number of human workers necessary to satisfy one or more of the completion rules specified in the completion criteria data. The human intelligence platform 120 can send the task for response by the minimum number of human workers. If the responses provided by the minimum number of human workers satisfy the completion criteria, the task can be considered completed without having to send the task to the predetermined maximum number of users. If the completion criteria is not satisfied, the human intelligence platform 120 can be configured to incrementally provide the task for response by one additional human worker until either the completion criteria is satisfied or the predefined maximum number of human workers is reached.

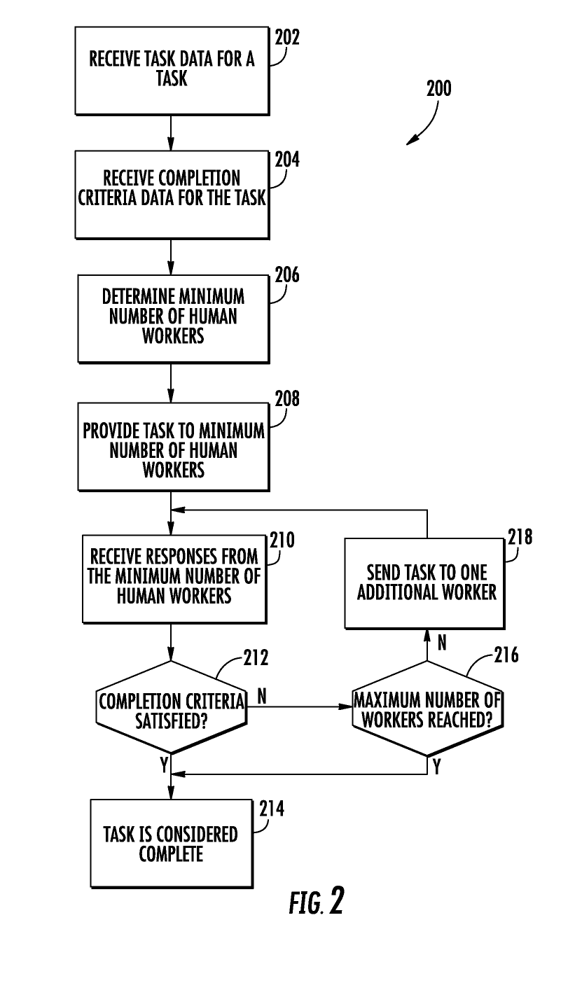

FIG. 2 depicts a flow diagram of a method (200) that can be implemented by human intelligence platform 120 to obtain a plurality of response from human workers in accordance with an exemplary embodiment of the present disclosure. The method (200) can be implemented by a processor of a computing device associated with the human intelligence system 100, such as the processor(s) 312 of FIG. 3. However, those of ordinary skill in the art, using the disclosures provided herein, should understand that the method (200) can be implemented using any suitable human intelligence system. In addition, although FIG. 2 depicts steps performed in a particular order for purposes of illustration and discussion, the methods discussed herein are not limited to any particular order or arrangement.

At (202), the method includes receiving task data associated with a particular task. For instance, a processor associated with a computing device of a human intelligence system can receive task data specified by a requestor. The task data can be defined in a task data structure that specifies one or more tasks for completion by human workers. As set forth above, the task data can also specify a maximum number of human workers for the task. The maximum number of human workers can be specified, for instance, in a replication field associated with the task data structure. The maximum number of human workers can be predefined to provide a desired accuracy level for the task.

At (204), the method includes receiving completion criteria data associated with the task. For example, a processor associated with a computing device of a human intelligence system can receive completion criteria data associated with the task. The completion criteria data can be defined in a completion criteria data structure specified by the requestor. The completion criteria data structure can specify one or more completion rules that when satisfied signify completion of a task. As discussed above, each of the completion rules can include a match count requirement, zero or more field constraints, and zero or more value constraints.

At (206), the method determines the minimum number of human workers necessary to satisfy the completion criteria data. For instance, a processor associated with a computing device of a human intelligence system can analyze the completion criteria data to determine the minimum number of human worker responses necessary to satisfy the completion criteria data. In one embodiment, the processor can analyze the completion criteria data to identify the lowest match count requirement for all completion rules defined in the completion criteria data. As an example, consider the first exemplary completion criterion discussed above specifies that a task is considered complete when two human workers agree on a response to the task. The lowest match count requirement for this exemplary completion criterion is two. The processor can be configured to determine that the minimum number of human workers to satisfy this exemplary completion criterion is two human workers.

As another example, consider the second exemplary completion criterion discussed above that specifies that that a task is complete when two human workers agree on a response in both fields “foo” and “bar” in a response data structure specified for the task. The lowest match count requirement for this exemplary completion criterion is two. The processor can be configured to determine that the minimum number of human workers to satisfy this exemplary completion rule is two human workers.

As yet another example, consider the third exemplary completion criterion discussed above that specifies that a task is complete if a single human worker responds with a “NO” response or if two human workers respond with a “YES” response. The lowest match count requirement for this exemplary completion criterion is one. The processor can be configured to determine that the minimum number of human workers to satisfy this exemplary completion rule is one human worker.

Once the minimum number of human workers is determined (206), the task is provided to the minimum number of human workers for response (208). For instance, a processor associated with a computing device of a human intelligence system can provide, via a network interface, the task to the minimum number of human workers for response. At (210), the responses to the task from the minimum number of human workers can be received. For instance, the processor associated with a computing device of a human intelligence system can receive response data from the minimum number of human workers over the network interface.

At (212), the method determines whether the completion criteria data is satisfied based on the responses received from the minimum number of workers. For instance, a processor associated with a computing device of a human intelligence system can analyze the responses to determine if one or more of the completion rules set forth in the completion criteria data structure are satisfied. If so, the method can determine that that task is considered to be completed (214). A status update can then be provided to a requestor indicating that the task has been completed in accordance with the completion criteria set forth by the requestor.

If the completion criteria are not satisfied, the method determines whether the maximum number of human workers have responded to the task (216). For instance, a processor associated with a computing device can compare the number of human workers that have provided a response with the maximum number of human workers specified in the task data structure. If the maximum number of human workers has been reached, the task can be considered completed (214). If not, the task can be incrementally provided to one additional human worker as shown at (218). The method can then reevaluate the responses to determine whether the completion criteria data is satisfied. The method can incrementally provide the task to one additional human worker until either the maximum number of human workers is reached or until the completion criteria is satisfied.

In this manner, sufficient responses can be obtained for a task without having to automatically send the task to a predefined maximum number of human workers. Rather, the task is sent to the minimum number of human workers necessary to satisfy completion criteria data associated with the task. As a result, human worker resources can be more efficiently allocated and expense associated with obtaining human worker responses to the task can be reduced.

Referring now to FIG. 3, an exemplary computer-based human intelligence system 300 that can be used to implement the subject matter of the present disclosure will be discussed in detail. As shown, human intelligence system 300 includes a computing device 310 that can be coupled to one or more requestor computing devices 320 and worker computing devices 330 over a network 340. One of requestor computing devices 320 is illustrated in dashed line to signify that any number of requestor computing devices 320 can be coupled to computing device 310. Similarly, one of worker computing devices 330 any number of worker computing devices 330 can be coupled to computing device 310.

The network 340 can include a combination of networks, such as cellular network, WiFi network, LAN, WAN, the Internet, and/or other suitable network and can include any number of wired or wireless communication links. The computing device 310 can include a network interface to allow communications with the requestor computing devices 320 and the worker computing devices 330 over the network 340. The computing device 310 can communicate information to requestor computing devices 320 and worker computing devices 330 in any suitable format over network 340. For instance, the information can include HTML code, XML messages, WAP code, Java applets, xhtml, plain text, voiceXML, VoxML, VXML, or other suitable format.

Computing device 310 can be a server, such as a web server, that exchanges information, including various tasks for completion, with requestor computing devices 320 and worker computing devices 330 over network 340. For instance, requestors can provide information, such as task data and completion criteria data, from computing devices 320 to computing device 310 over network 340. Human workers can provide response data for the tasks from computing devices 330 to computing device 310 over network 340.

The requestor computing devices 320 and the worker computing devices 330 can take any appropriate form, such as a personal computer, smartphone, desktop, laptop, PDA, tablet, or other computing device. The requestor computing devices 320 and the worker computing devices 330 can include a processor and a memory and can also include appropriate input and output devices, such as a display screen, touch screen, touch pad, data entry keys, speakers, and/or a microphone suitable for voice recognition. The requestor computing devices 320 and the worker computing devices 330 can be configured to display various information to requestors and workers through a suitable user interface.

Similar to requestor computing devices 320 and worker computing devices 330, computing device 310 can include a processor(s) 312 and a memory 314. The processor(s) 312 can be any known processing device. Memory 314 can include any suitable computer-readable medium or media, including, but not limited to, RAM, ROM, hard drives, flash drives, or other memory devices.

Memory 314 stores information accessible by processor(s) 312, including computer-readable instructions 316 that can be executed by processor(s) 312. The instructions 316 can be any set of instructions that when executed by the processor(s) 312, cause the processor(s) 312 to provide desired functionality, such as analyzing completion criteria data to determine a minimum number of human workers to satisfy the completion criteria data for the task. The instructions 312 can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to application-specific circuits.

Memory 314 can also include or be coupled to various databases containing accessible by processor(s) 312. For instance, memory 314 can store task data, completion criteria data, response data, data associated with workers, accuracy data, and other suitable data. In addition, computing device 310 can communicate with other databases as needed. The databases can be connected to computing device 310 by a high bandwidth LAN or WAN, or could also be connected to computing device 310 through network 340. The databases can be split up so that they are located in multiple locales.

While FIG. 3 illustrates one example of a computer-based human intelligence system that can be used to implement the methods of the present disclosure, those of ordinary skill in the art, using the disclosures provided herein, will recognize that the inherent flexibility of computer-based systems allows for a great variety of possible configurations, combinations, and divisions of tasks and functionality between and among the components. For instance, the computer-implemented methods discussed herein may be implemented using a single server or processor or multiple such elements working in combination. Databases and other memory/media elements and applications may be implemented on a single system or distributed across multiple systems.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of obtaining a plurality of responses to a task in a human intelligence system, the method comprising:
receiving, by one or more computing devices, a task for completion by a plurality of human workers, wherein the one or more computing devices comprise one or more processors;
receiving, by the one or more computing devices, completion criteria data for the task, the completion criteria data defining at least one completion rule that when satisfied signifies completion of the task;
determining, by the one or more computing devices, a minimum number of human workers to satisfy the completion criteria data for the task based on a match count requirement for the task, the match count requirement specifying a number of responses from human workers that must agree to satisfy the at least one completion rule;
providing, by the one or more computing devices, the task to the minimum number of human workers;
receiving, by the one or more computing devices, responses to the task from the minimum number of workers;
determining, by the one or more computing devices, whether the completion criteria data is satisfied based on the responses to the task from the minimum number of workers; and
incrementally providing, by the one or more computing devices, the task for completion by an additional human worker until the completion criteria data is satisfied.

2. The computer-implemented method of claim 2, wherein the completion criteria data defines a maximum number of human workers for the task, the method comprising incrementally providing, by the one or more computing devices, the task for completion by an additional human worker until the completion criteria data is satisfied or until the task has been provided to the maximum number of workers for the task.

3. The computer-implemented method of claim 1, wherein the completion criteria data is defined in a completion criteria data structure independent of a data structure associated with the task.

4. The computer-implemented method of claim 1, wherein the completion criteria data defines a plurality of completion rules for the task, wherein the completion criteria data is satisfied for the task upon satisfaction of any of the plurality of completion rules for the task.

5-6. (canceled)

7. The computer-implemented method of claim 1, wherein the completion criteria data comprises a plurality of match count requirements, wherein the minimum number of human workers is determined based on the match count requirement having the smallest value.

8. The computer-implemented method of claim 1, wherein the at least one completion rule comprises a match count requirement and at least one field constraint, the field constraint mapping the match count requirement to a field in a data structure associated with the response for the task.

9. The computer-implemented method of claim 8, wherein the field constraint further comprises a value constraint, the value constraint being satisfied when data in the field in the data structure associated with the response contains a value that matches the value constraint.

10. A human intelligence system, comprising:
a computing system having one or more processors, one or more memory devices, and at least one network interface, the computing system configured to receive, via the network interface, task data associated with a task for completion by a plurality of human workers and to receive completion criteria data for the task, the completion criteria data defining one or more completion rules that when satisfied signify completion of the task, each of the one or more completion rules comprising a match count requirement, the match count requirement specifying a number of responses from human workers that must agree to satisfy the completion rule; the one or more processors configured to execute computer-readable instructions stored in the one or more memory devices to cause the processor to perform operations, the operations comprising:
determining a minimum number of human workers to satisfy the completion criteria data for the task based at least in part on the match count requirement associated with the one or more completion rules, the match count requirement specifying a number of responses from human workers that must agree to satisfy the one or more completion rules; and
providing, via the network interface, the task to the minimum number of human workers;
determining whether the completion criteria data is satisfied based on the responses to the task from the minimum number of workers; and
incrementally providing, via the network interface, the task for completion by an additional human worker until the completion criteria is satisfied.

11. (canceled)

12. The human intelligence system of claim 10, wherein the completion criteria data defines a maximum number of human workers for the task, the processor configured to execute computer-readable instructions stored in the memory to cause the processor to perform the operation of incrementally providing the task for completion by an additional human worker until the completion criteria data is satisfied or until the task has been provided to the maximum number of workers for the task.

13. The human intelligence system, of claim 10, wherein the completion criteria data is defined in a completion criteria data structure independent of a data structure associated with a task.

14. The human intelligence system of claim 10, wherein at least one of the completion rules defines a field constraint, the field constraint mapping the match count requirement to a field in a data structure associated with a response for the task.

15. The human intelligence system of claim 14, wherein the field constraint further comprises a value constraint, the value constraint being satisfied when data in the field in the data structure associated with the response contains a value that matches the value constraint.

16. One or more tangible, non-transitory, computer-readable media having computer-readable instructions stored thereon that, when executed by one or more processors cause the one or more processors to:
receive task data defined in a first data structure associated with a task for completion by a plurality human workers;
receive completion criteria data defined in a second data structure, the completion criteria data comprising at least one completion rule that when satisfied signifies completion of the task;
analyze the completion criteria data to identify a minimum number of human workers to satisfy the completion criteria for the task based on a match count requirement for the task, the match count requirement specifying a number of responses from human workers that must agree to satisfy the at least one completion rule;
provide the task data to the minimum number of human workers;
receive response data to the task data from the minimum number of human workers, the response data defined in a third data structure;
determine whether the completion criteria data for the task is satisfied based on the response data; and
incrementally provide the task data to an additional human worker until the completion criteria data is satisfied.

17-18. (canceled)

19. The one or more tangible, non-transitory, computer readable media of claim 16, wherein the at least one completion rule comprises a match count requirement for the task and a field constraint, the field constraint mapping the match count requirement to a field in the third data structure.

20. The one or more tangible, non-transitory, computer readable media of claim 19, wherein the field constraint further comprises a value constraint, the value constraint being satisfied when data in the field in the third data structure contains a value that matches the value constraint.
